(19) United States
(12) Patent Application Publication
(10) Pub. No.: US 2019/0318665 A1
(43) Pub. Date: Oct. 17, 2019

(54) LABEL FACESTOCK FILM AND METHOD OF MANUFACTURING THE SAME

(71) Applicant: INNOVIA FILMS LIMITED, Wigton Cumbria (GB)

(72) Inventors: Elizabeth TATLOCK, Wigton Cumbria (GB); Jamie MOFFAT, Wigton Cumbria (GB); Jonathan HEWITT, Wigton Cumbria (GB); Stephen LANGSTAFF, Wigton Cumbria (GB)

(21) Appl. No.: 16/309,839

(22) PCT Filed: Jul. 4, 2017
(86) PCT No.: PCT/GB2017/051965

§ 371 Date: Dec. 13, 2018

(30) Foreign Application Priority Data
Jul. 4, 2016 (GB) 1611629.5

(51) Int. Cl. G09F 3/00; B65D 25/20; B65D 81/26; C09D 11/102

(52) U.S. Cl. CPC G09F 3/0291; B65D 25/205; G09F 2003/0283; C09D 11/102; B65D 81/267

(57) ABSTRACT

The present invention provides a label facestock film comprising a substrate web and a pattern of active material on a surface of the substrate web, wherein the substrate web comprises one or more label-forming regions and one or more matrix regions, and wherein the pattern of the active material is repetitive and forms a region of said surface that is free from any active material, wherein said region at least partially overlaps with one or more of the one or more matrix regions.

This application is a national stage application of International Patent Application No. PCT/GB2017/051965, filed Jul. 4, 2017, which claims priority to Great Britain patent Application No. 1611629.5, filed Jul. 4, 2016. The entirety of the aforementioned applications is incorporated herein by reference.

### FIELD

The present invention concerns a label facestock film, as well as a labelstock and label produced using such a film, a packaging including said articles and a method of making said film.

### BACKGROUND

Active materials are materials that interact with the environment in which they are placed in some way. Examples of active materials include materials that chemically react with the environment, such as ethylene or oxygen scavenging materials, as well as materials that change in some way in response to the environment, such as temperature or moisture indicators. Active materials have a wide range of uses, for example in food packaging to provide an indication of the conditions within the packaging or to prolong the shelf-life of the packaged goods.

When used in combination with films, active materials are generally applied as coatings using conventional methods such as aqueous flood coating as shown in, for example, WO2008110020. This type of coating provides an even coverage of the film and is a well-known technique. If the active material is particulate, it can be included in a binder before being coated onto the film. The term “active material” used herein covers the combination of a particulate active material and the binder in which it is held.

Packages can be made using films that are coated with an active material. However, this is relatively expensive, as the active material is an expensive component of the film and is present over the entire film surface. Alternatively, small structures including the active material can be placed loose in the packaging. However, such structures can be difficult to see from outside the packaging, are often undesirable to brandowners, retailers and consumers, and may pose a risk of ingestion to the consumer.

WO2014132065 discloses a film comprising an indicator material that can be printed onto the substrate. The film can be used to make labels that are then attached to a packaging.

WO2006077413, WO2006011926, WO2008149232, WO2007130737, U.S. Pat. No. 9,320,288 and WO2012135085 also discuss films comprising an active material. These documents disclose that the film including the active material may be used as a patch or label in a larger structure, such as in packaging.

The use of labels can significantly reduce the cost of a packaging, as it means that the entire packaging structure does not have to be made out of a material including the active material. Less active material is therefore used, which can significantly reduce the cost, as it is the active material that is the most expensive part of the structure. Additionally, the label can be positioned within the structure in order to maximize efficacy and so that it can be easily seen.

However, due to the cost of the active material, there is a requirement for a film or label that includes an active material but that is less expensive to manufacture.

### BRIEF DESCRIPTION OF THE DRAWINGS

The invention will now be more particularly described with reference to the following figures, in which:

FIG. 1 illustrates a possible facestock film layer arrangement, in the region of the substrate surface that comprises the active material;

FIG. 2 illustrates a larger section of the facestock film, showing the regions of the substrate surface both with and without the active material; and

FIG. 3 illustrates a printed film according to the embodiment of the invention disclosed in Example 2.

### DETAILED DESCRIPTION

According to the present invention there is provided a label facestock film comprising a substrate web and a pattern of active material on a surface of the substrate web, wherein the substrate web comprises one or more label-forming regions and one or more matrix regions, and wherein the pattern of the active material is repetitive and forms a region of said surface that is free from any active material, wherein said region at least partially overlaps with one or more of the one or more matrix regions.

The formation of labels from a facestock film or a labelstock involves cutting the film at regular intervals in order to create the labels. The cuts are generally made around the one or more label-forming regions, so that the labels can be removed from the rest of the film. This involves the creation of a matrix as well as the labels, the matrix consisting of the parts of the facestock film that surround the labels but do not form the labels themselves. The matrix is therefore waste produced by the label manufacturing process. The facestock film therefore comprises label-forming regions, which will create the labels once the cuts have been made, as well as matrix regions, which will form the matrix waste.

Methods of cutting labels, such as die cutting, are well known in the art. However, the one or more matrix regions and the one or more label-forming regions of the facestock film may be determined during the creation of the facestock film, before the cuts are made. For example, components such as any ink that is applied to the facestock film can define the different regions.

Having a region of the substrate surface that is free from any active material reduces the overall amount of active material used in the facestock film and therefore also the amount used in the labels created from the facestock film. As it is the active material that is the expensive component of the facestock film, this can significantly decrease the cost of the facestock film.

Including a region of substrate surface that does not include an active material in one or more of the one or more matrix regions of the facestock film means that less active material is lost as waste during the process of creating labels from the facestock film. As it is the active material that is the expensive component of the label, reducing the amount that is wasted can significantly reduce the overall cost of producing the labels.

Where there is a plurality of label-forming regions, the pattern of the active material may be repetitive such that it repeats at intervals that correspond to the intervals between the label-forming regions. Thus, each of the labels formed from the facestock film may comprise an isolated region of active material. This means that the active material can create two patterns. The first pattern is formed by the repetition of the regions of active material at intervals that correspond to the intervals between the label-forming regions, thereby forming a pattern of regions of active material over the facestock film. Each region of active material may correspond to a single label-forming region. However, the active material may also be patterned within each region on each label-forming region, thereby creating a second pattern. Each region of the active material on each label-forming region may have the same or a different pattern.

Alternatively, the intervals between the label-forming regions and the active material pattern repeats may not align. Each of the label-forming regions of the facestock film may therefore have different active material patterns.

Used herein, a “web” refers to a continuous length of film that can be wound onto a reel. A “facestock” refers to the film that is used to produce the labels before the labels have been cut and do not include a release liner. A “labelstock” comprises the facestock and a release liner.

The active material is applied to the substrate surface in a pattern and the region of the substrate surface that is free from any active material is created by the pattern of the active material on the substrate surface. Methods of creating a pattern on a substrate surface are well known in the art. For example, the active material may be printed on the substrate surface, using flexographic printing or other printing methods known in the art.

The use of a pattern of active material can increase the surface area of the active material. The pattern can therefore be selected to increase the surface area of the active material. This means that more of the active material is in contact with the environment with which it interacts, which will increase the efficiency of the reaction between the active material and the environment, such as ethylene or oxygen scavenging.

The pattern can also create a tailored loading of the active material to suit specific end applications, based on factors such as print area. For example, the pattern may be denser, i.e. have more active material per unit area, in some regions of the facestock film or label than in other regions.

The pattern may be a uniform pattern, such as crosshatching, parallel lines or arrangements of dots. This uniform pattern can extend over the entire substrate surface, including over the one or more matrix regions. This is an easy and cheap way of printing the active material and it means that the pattern of the active material does not have to be aligned exactly to the position of the label-forming regions. As the waste matrix regions of the facestock film will only include portions of the active material and will also include regions that are free from the active material, less active material will be wasted compared to films that have a continuous coating of the active material. This can significantly reduce the cost of producing the labels.

The region of the substrate surface that is free from any active material overlaps with at least part of one or more of the one or more matrix regions. The region of the substrate surface that is free from any active material may extend over all of one or more of the one or more matrix regions. The region of the substrate surface that is free from any active material may extend beyond one or more of the one or more matrix regions. Preferably, the region of the substrate surface that is free from any active material extends over all of the matrix regions of the facestock film. In this embodiment, no active material will be present on the matrix waste produced during the production of the labels from the label facestock film.

This embodiment requires the application of the active material to align with the position of the label-forming regions. However, this also means that no active material is lost during the creation of the labels as part of the matrix waste.

The active material may be any material that interacts with its surrounding environment. For example, the active material may be an ethylene scavenger, an oxygen scavenger, a moisture scavenger, a temperature indicator, a moisture indicator, an antimicrobial agent or a material that is sensitive to oxidizing agents, reducing agents, carbon dioxide, ammonia, pH and/or light, such as UV light.

The active material may comprise active material particles held in a binder. For example, a suitable active material comprising ethylene scavenging particles held within a binder is discussed in GB1508068.2.

The active material particles are preferably protuberant from the binder, in that they extend out from the surface of the binder layer. They may extend beyond the thickness that the binder layer would be if the particles were not present. They may extend beyond the thickness of the binder layer present between particles, when the particles are present in the layer. The particles may still be covered by a thin layer of binder, which can anchor them within the binder layer but still allows any compounds that are necessary for the active material to perform its function, such as ethylene in the case of ethylene scavengers, to reach the active material particles. Alternatively, some of the particles may be exposed such that no binder is present over part of their surface, although the term “protuberant” does not necessarily require this.

The protuberance can improve the efficiency of reaction carried out by the active material particles, as it can increase the surface area of the active material particles in contact with the environment. The protuberance can also improve the kinetics of the reaction, as compounds do not have to pass through large amounts of binder to reach the active material particles.

The protuberance can be created in a number of ways, such as using a high concentration of the active material particles in the binder layer, by using a small amount of a binder material and/or by selecting the size of the particles with reference to the binder layer thickness, such that it is greater in at least one dimension than the binder layer. If a high amount of particles is used in the binder, the particles may be in contact with each other along the axis perpendicular to the surface of the substrate, between the substrate and the surface of the binder layer, in a stacking arrangement.

Particle size may mean any one or more of d1-99, for example d10, d50 or d90.

The arithmetic mean particle size (or diameter) may be used.

The substrate web is preferably a polymer film, such as a biaxially orientated polypropylene film. The substrate web may be transparent, opaque or translucent and may be white, colourless, coloured or metallized. If the substrate web is opaque or translucent, this can provide a contrast with any print design applied to the substrate web, or with the surface to which the label is applied. If the substrate web is transparent, the active material can be viewed from both sides of the label and so any visible changes can be easily seen.

The film or the active material may comprise one or more functional materials for other purposes in relation to the functional or aesthetic characteristics of the film. Suitable functional materials may be selected from one or more of the following, mixtures thereof and/or combinations thereof: UV absorbers, dyes; pigments, colorants, metallized and/or pseudo-metallized coatings; lubricants, anti-static agents (cationic, anionic and/or non-ionic, e.g. poly-(oxyethylene) sorbitan monooleate), anti-oxidants (e.g. phosphorous acid, tris(2,4-di-tert-butyl phenyl) ester), surface-active agents, stiffening aids, slip aids (for example hot slips aids or cold slip aids which improve the ability of a film to slide satisfactorily across surfaces at about room temperature, e.g. micro-crystalline wax); gloss improvers, prodegradants, barrier coatings to alter the gas and/or moisture permeability properties of the film (such as polyvinylidene halides, e.g. PVdC); anti-blocking aids (for example microcrystalline wax, e.g. with an average particle size from about 0.1 to about 0.6 min); tack reducing additives (e.g. fumed silica, silica, silicone gum); particulate materials (e.g. talc); plasticizers; additives to increase COF (e.g. silicon carbide); additives to remove malodorous materials from the surrounding environment; additives to improve ink adhesion and/or printability, additives to increase stiffness (e.g. hydrocarbon resin) and additives to increase shrinkage (e.g. hard resin).

The facestock film may further comprise a barrier layer, which extends over at least part of the active material and protects it during use. The barrier layer is preferably not removable from the facestock film. The active material may be positioned between the substrate web and the barrier layer. The barrier layer preferably prevents compounds that are detrimental to the active material from passing through it, but allows compounds that are necessary for the active material to perform its function to reach the active material. The barrier layer may also protect the active material from dusting and may improve the aesthetics, heat sealability, printability or peelability of the film.

For example, some ethylene scavengers such as zeolites are sensitive to moisture. If the active material comprises a zeolite, the barrier layer may therefore act to prevent water from reaching the zeolite, while still allowing ethylene to pass through the barrier layer.

Additionally or alternatively, the barrier layer may reduce the level of migration of undesirable constituents from the active material. This can prevent such constituents contacting the contents of a package, such as a foodstuff, thereby enabling compliance with food contact regulations.

The barrier layer may be a continuous coating and may be formed from a polymer or a non-woven material. The barrier may be a polyolefin and further may be made from polyethylene fibres. Tyvek (a flashspun high-density polyethylene fibre material) is a suitable barrier material.

A seal may form between the barrier layer and the substrate surface in the region of the substrate surface that is free from the active material. This can encapsulate the active material between the substrate web and the barrier layer, thereby ensuring that any compounds in the environment that are detrimental to the active material, such as water in the case of zeolites, cannot reach the active material, as well as preventing migration of constituents of the active material.

At least part of the region of the substrate surface that is free from the active material may comprise a material that enhances the sealing between the substrate web and the barrier layer. This can increase the seal strength, thereby reducing the chance that the barrier layer will be removed from the facestock film during use, which would expose the active material. This can also decrease the risk that compounds that are detrimental to the active material will reach it, or that components of the active material will escape into the environment. Suitable materials include, but are not limited to, polyethyleneimine, polyurethane, polyacrylic acids, polyvinylalcohol, polyvinypyrrolidone, polyisocyanates and polyaziridines.

The region of the substrate surface that is free from the active material may be flush with the active material. This can be due to the application of a material to said region of the substrate surface, such as a material that enhances the sealing between the substrate surface and the barrier layer. Having the two regions flush with one another can improve the sealing of the barrier layer to the region of the substrate surface.

The facestock film may further comprise a printed design formed using an ink. The ink may be applied to the substrate web and/or the barrier layer. The ink can be applied to the surface of the substrate web that comprises the active material, or the surface opposite said surface. The inks may be low migration and/or food contact inks. This can result in different designs on either side of the label if the substrate web is opaque or translucent. If the substrate web is transparent, the design may be the same when viewed from either side of the label. When the label is applied to the inside of a packaging, the print may therefore be visible from the outside of the packaging.

The pattern of the active material may be incorporated into the printed design. In other words, the visual effect or pattern created by the active material and the regions free from the active material may form part of the overall label design, in combination with the printed design. This can create a level of complexity in the visual effects formed. The active material may provide desirable optical and/or haptic effects.

The active material is preferably present on one surface of the substrate web. The substrate web may also have an adhesive layer on one surface, which may be opposite the surface to that which the active material is applied. This means that when the facestock film is applied to the inside of a packaging, the active material is orientated towards the inside of the packaging.

The adhesive may be a pressure sensitive adhesive and may be a low migration and/or a food contact adhesive. The adhesive may also be of sufficient transparency to enable any print to be visible through it. If a printed design is applied to the surface of the substrate web opposite that to which the active material is applied, the adhesive may extend over at least part of the printed design. A release liner may then be adjacent the adhesive.

The region of the substrate surface that is free from the active material may be positioned between the active material and another component of the facestock film, such as a printed ink pattern. This can act to isolate the active material from the other component. In other words, the region of the substrate surface that is free from the active material may separate the active material from another component of the facestock film. This can be used to provide a specific visual effect, or to minimize potential contamination and/or poisoning of the active material.

The other component from which the active material (i.e. the first active material) may be isolated can be a second active material that is different to the VOC scavenger material. The second active material may be any material that interacts with its surrounding environment. For example, the active material may be an ethylene scavenger, an oxygen scavenger, a moisture scavenger, a temperature indicator, a moisture indicator, an antimicrobial agent or a material that is sensitive to oxidizing agents, reducing agents, carbon dioxide, ammonia, pH and/or light, such as UV light.

This second active material may also be on a surface of the substrate web, which may be the same surface as that comprising the first active material. The separation of the two active materials may be necessary to prevent contamination and/or poisoning of one or both of the materials or to provide a specific visual effect. Additionally, the two active materials may require different conditions to function, for example they may be sensitive to different compounds and so may require different barrier layers or binders.

The second active material may be applied in a pattern, which preferably corresponds to the pattern of the first active material. The pattern of the second active material may be incorporated into the print design, as with the first active material. The second active material may provide desirable optical and/or haptic effects.

The label facestock film may further comprise cuts through at least part of the facestock film in order to create labels. The cuts may extend around at least one of the at least one label-forming regions, thereby separating the label-forming regions from at least one of the at least one matrix regions and creating a matrix waste. Preferably, cuts are made around all of the label-forming regions.

According to a second aspect of the present invention, there is provided a labelstock comprising the label facestock film as discussed above and a release liner.

Alternatively, the facestock may be a linerless facestock.

According to a third aspect of the present invention, there is provided a label produced using the label facestock film or the labelstock discussed above. The label may be formed from the facestock film or the labelstock by cutting the facestock film around one or more of the one or more label-forming regions, thereby separating the label-forming regions from one or more of the one or more matrix regions. This can lead to the creation of a matrix waste product.

According to a fourth aspect of the present invention, there is provided a packaging including the label facestock film, the labelstock or the label discussed above. This provides a low cost packaging that includes an active material, as including a label facestock film, a labelstock or a label having an active material is significantly cheaper than creating a packaging entirely out of a film including an active material. The label facestock film, the labelstock or the label may also be positioned as appropriate on the packaging, such that it is easily visible and can be applied at the appropriate time during its manufacture.

The label facestock film, the labelstock or the label may be applied to a polymeric web that is to be used as a flow wrap. The label facestock film, the labelstock or the label could be applied to the surface of the web that would ultimately form the inside of the flow wrapped pack.

The label facestock film, the labelstock or the label may be applied to a polymeric web that is used as a lidding film for a tray, where the label facestock film, the labelstock or the label could be applied to the surface of the web that would be orientated towards the inside of the lidded tray.

The label facestock film, the labelstock or the label may be applied to a pre-formed tray that forms all or part of a packaging solution or product display.

According to a fifth aspect of the present invention, there is provided a method of manufacturing a label facestock film for producing labels as discussed above, comprising applying an active material to a substrate web surface such that a region of the substrate surface is free from the active material. The active material may be applied in a pattern and may be printed onto the substrate surface, using a method such as flexographic printing. Preferably, the region of the substrate surface that is free from the active material overlaps with at least part of one or more of the one or more matrix regions of the facestock film. The region of the substrate surface that is free from the active material may entirely cover and/or may extend further than one or more of the one or more matrix regions.

The method may further comprise the step of creating one or more label by cutting the facestock film. The cuts may be made around one or more of the one or more label-forming regions, thereby separating the one or more label-forming regions and one or more of the one or more matrix regions. Preferably, cuts are made around all of the label-forming regions of the facestock film.

This method may be a method for reducing the cost of manufacturing labels from a label facestock film.

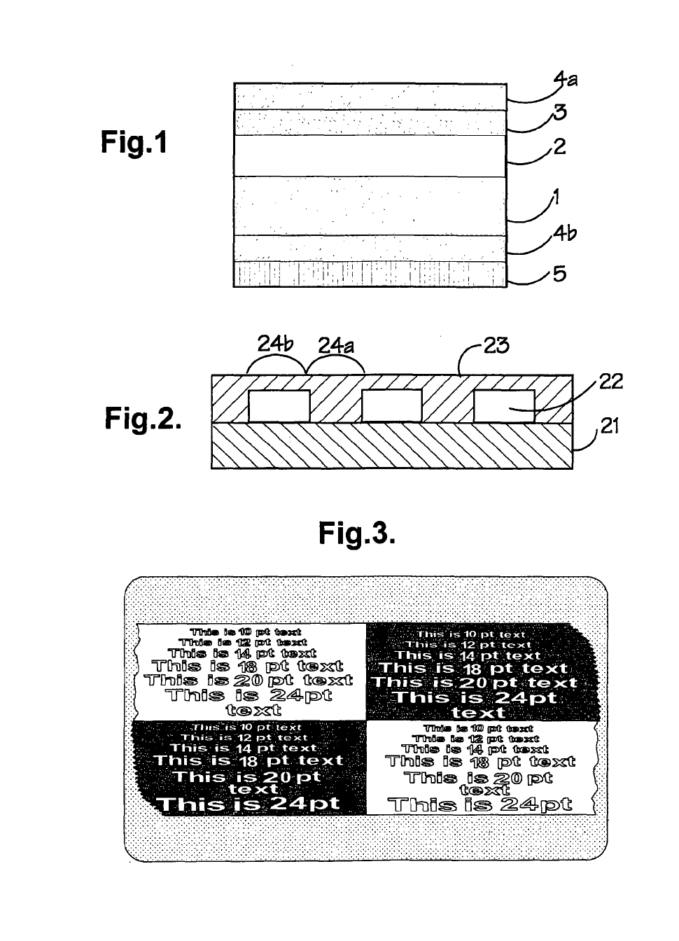

FIG. 1 shows substrate web 1 comprising a polymeric film, onto which active material 2 has been printed. Active material 2 is covered with a functional barrier layer 3. The facestock film comprises two print layers comprising low migration and food contact inks, the first print layer 4a being applied over the barrier layer, while the second print layer 4b is applied to the substrate web 1, on the surface opposite the active material 2. A pressure sensitive adhesive 5 is applied over the second print layer 4b.

It is to be understood that FIG. 1 only shows the region of the substrate web where the active material has been applied to the surface. There will therefore be regions, adjacent those with the structure shown in FIG. 1, do not comprise the active material, i.e. regions that do not have active material layer 2. FIG. 2 illustrates how the regions may be arranged relative to one another.

Specifically, FIG. 2 shows substrate web 21 comprising a polymeric film, onto which active material 22 has been printed. Active material 22 has been applied so that there are regions 24a of the substrate surface that are free of active material, in contrast to the regions 24b that are in contact with the active material. The matrix regions of the film will be located within regions 24a.

A functional barrier layer 23 has been applied over the active material 22, thereby protecting it from the surrounding environment. Barrier layer 23 is also in contact with substrate web 21 in the regions 24a of the substrate surface that are free of active material. The barrier layer 23 binds to the substrate web 21 in these regions.

The following examples are intended to demonstrate one way of making use of the invention and are not intended to be limiting to the scope of the invention.

### Example 1

An ink containing a scavenging zeolite material (ZSM-5), was formulated using a polyurethane binder (NeoRez R-610™). The ink had a total solids content of 25% and a ratio of zeolite:binder of 5:1. The scavenger was dispersed in water in a solution of 40% solids and sonicated for 3 minutes to remove agglomeration of particles. The scavenger dispersion was then added to the polyurethane binder system to form the ink.

0.5 gsm of a polyurethane primer was applied to a white 50 micron biaxially orientated polypropylene (BOPP) film using a yellow K-bar. The primer was then air-dried prior to printing. The ink containing ZSM-5 was applied to the BOPP film with a surface energy of 38 Dynes/cm (Innovia Films Ltd) using flexographic printing techniques. Specifically, a Flexiproofer 100/UV was used, without utilising utilizing the UV capabilities, with a banded anilox roller having two cell volumes (13 cm³/m² and 18 cm³/m²). The ink was applied to the film four times, with air drying between each application. This created a pattern of light and dark bands on the film surface, separated by regions of unprinted film.

Ethylene uptake was measured on duplicate samples and compared to the ethylene uptake of a ZSM-5 sample. The sample of ZSM-5 and each of the printed film samples were placed into separate 20 ml glass headspace vials and crimp sealed with butyl rubber septa. 3000 μl of ethylene (100%) was injected into each of the sealed vials. Corresponding empty vials without any sample were similarly prepared for use as calibration standards. The prepared samples were left to stand at ambient lab conditions for four days prior to GC-FID analysis.

The amount of ZSM-5 in the replicates was calculated so that the results could be directly compared. In order to obtain this value, a sample area of 35 cm² of the printed film was placed into a ceramic crucible and heated to 750° C. in a muffle furnace for 3 hours. This process burned all organic matter, leaving residual inorganic matter in the crucible. The crucible weight was recorded before and after the heating process and the difference in mass was used to determine the amount of active scavenger on the surface of the film. A reference sample of white BOPP was also heated to ensure that any inorganic matter in the film, such as TiO₂, was not included as residual scavenger material.

The total ash content of white 50 micron BOPP was determined as 4.5 gsm and the residual inorganic material for the screen printed material was 7 gsm. Deducting the inorganic material characteristic of the BOPP gave an active content of 2.5 gsm.

The ethylene uptake results are illustrated in Table 1, which includes data that has been normalized based on the amount of ZSM-5 present in the replicates, thereby allowing comparison with the ethylene uptake of ZSM-5 alone. As demonstrated in Table 1, the films containing the patterned print demonstrate a similar ethylene uptake to that of ZSM-5 alone. Thus, the rate of ethylene uptake is not detrimentally affected by including the ZSM-5 in a patterned print.

TABLE 1

| Sample | Ethylene uptake (μl) | Normalised data (μl/g) |
|---|---|---|
| ZSM-5 | 246 | 82000 |
| Print Replicate 1 | 198 | 78749.99 |
| Print Replicate 2 | 212 | 84318.17 |

### Example 2

The same ink as used in Example 1 was screen printed on a BOPP film with a surface energy of 38 Dynes/cm (Innovia Films Ltd). The ink was applied using a screen with 120 threads crossing/square inch, creating a checkerboard print pattern including text, as shown in FIG. 3. The print showed 100% adhesion to the base film through a tape test.

Ashing of the sample was conducted using the same method as outlined in Example 1. The residual inorganic material for the screen printed material was 10 gsm and so deducting the inorganic material characteristic of the BOPP gave an active content of 5.5 gsm.

Ethylene uptake of the samples was assessed in the same way as outlined in Example 1 and the results are shown in Table 2, which includes data that has been normalised based on the amount of ZSM-5 present in the replicates, thereby allowing comparison with the ethylene uptake of ZSM-5 alone. As demonstrated in Table 2, while the films containing a patterned print show a reduction in ethylene uptake compared to ZSM-5 alone, this reduction is not sufficient to be problematic. Thus, including the ZSM-5 in a patterned print provides a sufficient level of ethylene uptake in the replicates.

TABLE 2

| Sample | Ethylene uptake (μl) | Normalized data (μl/g) |
|---|---|---|
| ZSM-5 | 246 | 82000 |
| Print Replicate 1 | 279 | 50727.27 |
| Print Replicate 2 | 243 | 44181.81 |

1. A label facestock film comprising a substrate web and a pattern of active material on a surface of the substrate web,
wherein the substrate web comprises one or more label-forming regions and one or more matrix regions, and
wherein the pattern of the active material is repetitive and forms a region of said surface that is free from any active material, wherein said region at least partially overlaps with one or more of the one or more matrix regions.

2. The label facestock film according to claim 1, wherein the pattern increases the surface area of the active material.

3. The label facestock film according to claim 1, wherein the pattern is a uniform pattern such as crosshatching.

4. The label facestock film according to claim 1, wherein the region of the substrate surface that is free from any active material extends over all of one or more of the one or more matrix regions.

5. The label facestock film according to claim 1, wherein the active material is an ethylene scavenger, an oxygen scavenger, a moisture scavenger, a temperature indicator, a moisture indicator or an antimicrobial agent.

6. The label facestock film according to claim 1, further comprising a barrier layer that extends over at least part of the active material and protects it from at least one compound during use.

7. The label facestock film according to claim 6, wherein the barrier layer is a polymer or a non-woven material.

8. The label facestock film according to claim 1, wherein a seal forms between the barrier layer and the substrate surface in the region of the substrate surface that is free from the active material.

9. The label facestock film according to claim 8, wherein at least part of the region of the substrate surface that is free from the active material comprises a material that enhances the sealing between the substrate surface and the barrier layer.

10. The label facestock film according to claim 1, wherein the region of the substrate surface that is free from the active material is flush with the active material.

11. The label facestock film according to claim 1, further comprising a printed design formed using an ink.

12. The label facestock film according to claim 11, wherein the pattern of the active material is incorporated into the printed design.

13. The label facestock film according to claim 1, wherein the region of the substrate surface that is free from the active material is positioned between the active material and another component of the facestock film.

14. The label facestock film according to claim 13, wherein the other component is a second active material on the substrate surface comprising the first active material.

15. The label facestock film according to claim 1, wherein cuts have been made through at least part of the facestock film around at least one of the at least one label-forming regions, in order to separate said label-forming regions from at least one of the at least one matrix regions.

16. A labelstock comprising the label facestock film of claim 1 and a release liner.

17. A label produced using the label facestock film according to claim 1.

18. A packaging including the label facestock film according to claim 1.

19. A method of manufacturing a label facestock film according to claim 1, comprising applying an active material to a surface of a substrate web such that a region of the substrate surface that is free from the active material at least partly overlaps with one or more of the one or more matrix regions of the label facestock film.

20. A label produced using the labelstock according to claim 16.

21. A packaging including the labelstock according to claim 16.

22. A packaging including the label according to claim 17.
